(19) United States
(12) Patent Application Publication
(10) Pub. No.: US 2002/0181739 A1
(43) Pub. Date: Dec. 5, 2002

(54) Video system for monitoring and reporting weather conditions

(75) Inventors: Robert G. Hallowell, Nashua, NH (US); Michael P. Matthews, Billerica, MA (US); David A. Clark, Walpole, MA (US)

Correspondence Address: TESTA, HURWITZ & THIBEAULT, LLP, HIGH STREET TOWER, 125 HIGH STREET, BOSTON, MA, 02110, US

(73) Assignee: MASSACHUSETTS INSTITUTE OF TECHNOLOGY, CAMBRIDGE, MA (US)

(21) Appl. No.: 10/162,426

(22) Filed: Jun. 4, 2002

Related U.S. Application Data
(60) Provisional application No. 60/295,688, filed on Jun. 4, 2001.

(51) Int. Cl. G06K 9/40

(52) U.S. Cl. 382/100; 382/199; 382/274

(57) ABSTRACT

A method and apparatus for identifying a weather condition from visible imagery. A sequential series of visible images depicting a field of view is received. A composite visible image representing a long-term average of the monitored field of view is maintained and updated with each subsequent image. Each received image and the composite visible image are edge-detection filtered. Persistent edges existing in both the received image and the composite visible image are extracted and used to predict a weather condition. In one embodiment, a statistical value determined from the extracted edge image is used to predict visibility using a predetermined scoring function.

### CROSS-REFERENCE TO RELATED APPLICATIONS

This application claims the benefit of provisional patent application serial No. 60/295,688, filed Jun. 4, 2001, the entirety of which is incorporated herein by reference.

### STATEMENT REGARDING FEDERALLY SPONSORED RESEARCH OR DEVELOPMENT

The subject matter described herein was supported in part under Contract Number F19628-00-C-0002 awarded by the U.S. Department of the Air Force.

### FIELD OF THE INVENTION

The invention relates generally to a process and system for monitoring and reporting weather conditions. In particular, the invention relates to a method for estimating visibility using imagery obtained from one or more visible image sources of opportunity.

### BACKGROUND OF THE INVENTION

The availability of accurate and up-to-date information relating to weather conditions at desired locations is important for travelers, particularly when adverse weather conditions are being reported. Travelers armed with accurate, current weather information can use the information to assist in trips in the planning stages, such as choosing alternate travel destinations, times, and/or travel routes. Such information would also be useful to a traveler en-route, allowing routes to be altered and/or stops to be planned in order to avoid dangerous weather conditions. By taking weather into consideration in planning any trip, a traveler can travel economically by reducing travel time and fuel consumption, as well as increasing safety margin by minimizing the likelihood of encountering a weather-related accident.

Often, weather conditions are localized, occurring in a small geographical area, such as small-cell storms and fog. As such, the local conditions may not be reported with sufficient specificity by current weather systems, such as radar and satellite systems. These systems may identify small cell storms, but an associated weather report would doubtfully pinpoint a storm's location within any particular community. Other methods of weather sensing include instrumenting a roadway or intersection with custom weather sensors, then communicating the sensed weather conditions to a weather dissemination system. These custom systems can be costly to install and can also require costly additional maintenance.

As traffic continues to increase on many roadways and in urban areas with expectations of continued growth, many roadways have been outfitted with cameras providing video imaging (traffic cams). Often, the video imaging is reported to a traffic center, or even made available on the Internet. It would be advantageous to use these existing video image sensors to determine localized weather conditions. Unfortunately, weather reporting from the video images is operator intensive, requiring an operator to view the image, make a determination of the weather condition, such as visibility, for each observed image, based on the particular field of view of each camera and generate a message including the identified weather condition.

### SUMMARY OF THE INVENTION

The present invention provides a system and a process for identifying a weather condition, such as visibility, with minimal operator intervention using visible images received from one or more detection devices of opportunity.

In a first aspect the invention includes a computerized process for determining a weather condition using visible imagery by first receiving a series of sequential visible images each depicting substantially the same field of view. A composite visible image depicting the same field of view is next determined based on the received plurality of sequential visible images. In one embodiment, the composite visible image is determined as a weighted average of the received visible images. An edge-detected image is determined for each of the then currently-received image and the composite visible image. The determined edge-detected images are compared and expected edges within the currently-received image are used for further processing. In some embodiments, an expected-edge image intensity value is determined according to statistics of pixel intensities within the expected-edge image. A weather condition, such as visibility, is determined using the pixel intensity value and a predetermined scoring function.

In some embodiments, the images are digital video camera images, such as those obtained from roadway traffic monitoring cameras. In other embodiments, the mean intensity of each received image is calibrated according to a predetermined, clear-day brightness variation. In some embodiments, the determined weather condition is stored locally and available by request. In other embodiments, the determined weather condition is automatically disseminated to one or more users.

In another aspect, the invention includes a system for automatically determining a weather condition using visible imagery. The system includes an image input for receiving a series of sequential visible images where each received image depicts substantially the same field of view. The system also includes an image processor in communication with the image input for determining a composite visible image of the same field of view based on the received series of sequential visible images. The system also includes a filter in communication with the image input and the image processor for generating a first edge-detected image based on the currently-received visible image and a second edge-detected image based on the composite visible image. The system also includes a comparator in communication with the filter for comparing the fist and second edge-detected images, and a weather processor in communication with the comparator for determining a weather condition based on the comparison of edge-detected images.

In some embodiments, the system receives images from a digital video camera, such as those obtained for monitoring roadway traffic. In some embodiments, the system includes a user interface through which the determined weather conditions are automatically disseminated to one or more users. In other embodiments, the system stores the determined weather conditions locally. In another embodiment, the system includes a network interface, through which received visible images can be obtained, and/or user message identifying the determined weather condition disseminated.

In yet another aspect, the invention includes a computerized apparatus for determining a weather condition using visible imagery comprising including means for receiving a plurality of sequential visible images each depicting substantially the same field of view. The system also includes means in communication with the receiving means for determining a composite visible image depicting the field of view based on the received plurality of sequential visible images. The system also includes means in communication with the receiving means and the determining means for generating a first edge-detected image based on the currently-received visible images and the a second edge-detected image based on the composite visible image. The system also includes means in communication with the receiving means and the generating means for comparing the fist and second edge-detected images. And, the system includes means in communication with the comparing means for determining a weather condition based on the comparison of edge-detected images.

In some embodiments, the system includes means for sending messages to one or more users disseminating the determined weather condition.

### BRIEF DESCRIPTION OF THE DRAWINGS

The invention is pointed out with particularity in the appended claims. The advantages of the invention may be better understood by referring to the following description taken in conjunction with the accompanying drawing in which:

FIG. 1 flowchart representation of a method for determining a weather condition based on a visible image according to an embodiment of the invention;

FIG. 2 is a more detailed flowchart depicting a method for determining a composite visible image according to an embodiment of the invention shown in FIG. 1;

FIG. 3 more detailed flowchart depicting a method for calibrating a received visible image according to an embodiment of the invention shown in FIG. 1;

FIG. 4 is a more detailed flowchart depicting a method for comparing detected edges between the received visible image and the composite visible image according to an embodiment of the invention shown in FIG. 1;

FIG. 5 is a block diagram of an embodiment of an apparatus for determining a weather condition based on a visible image according to the present invention;

FIG. 6 is a block diagram of an alternative embodiment of an apparatus for determining a weather condition based on a visible image according to the present invention;

FIG. 7 is a block diagram of an embodiment of a system for determining a weather condition based on a visible image using the invention depicted in FIG. 5;

FIG. 8 is an illustration of a scoring function relating a weather parameter to the extracted, edge-detected image according to an embodiment of the invention;

FIGS. 9A through 9D are illustrations depicting a composite visible image, a currently-received image, and each of their corresponding edge-detected images, respectively, according to one embodiment of the invention;

FIGS. 10A through 10D are illustrations depicting an extracted, edge-detected image under different weather conditions, according to one embodiment of the invention; and

FIGS. 11A through 11B are illustrations depicting an extracted, edge-detected image and a corresponding edge-detected image under certain weather conditions according to one embodiment of the invention.

### DETAILED DESCRIPTION OF THE INVENTION

The present invention relates to an improvement in the method and apparatus for identifying a weather condition from visible imagery. A sequential series of visible images depicting a field of view is received. A composite visible image representing a long-term average of the monitored field of view is maintained and updated with each subsequent image. Each received image and the composite visible image are edge-detection filtered. Persistent edges existing in both the received image and the composite visible image are extracted and used to predict a weather condition. In one embodiment, a statistical value determined from the extracted edge image is used to predict visibility using a predetermined scoring function.

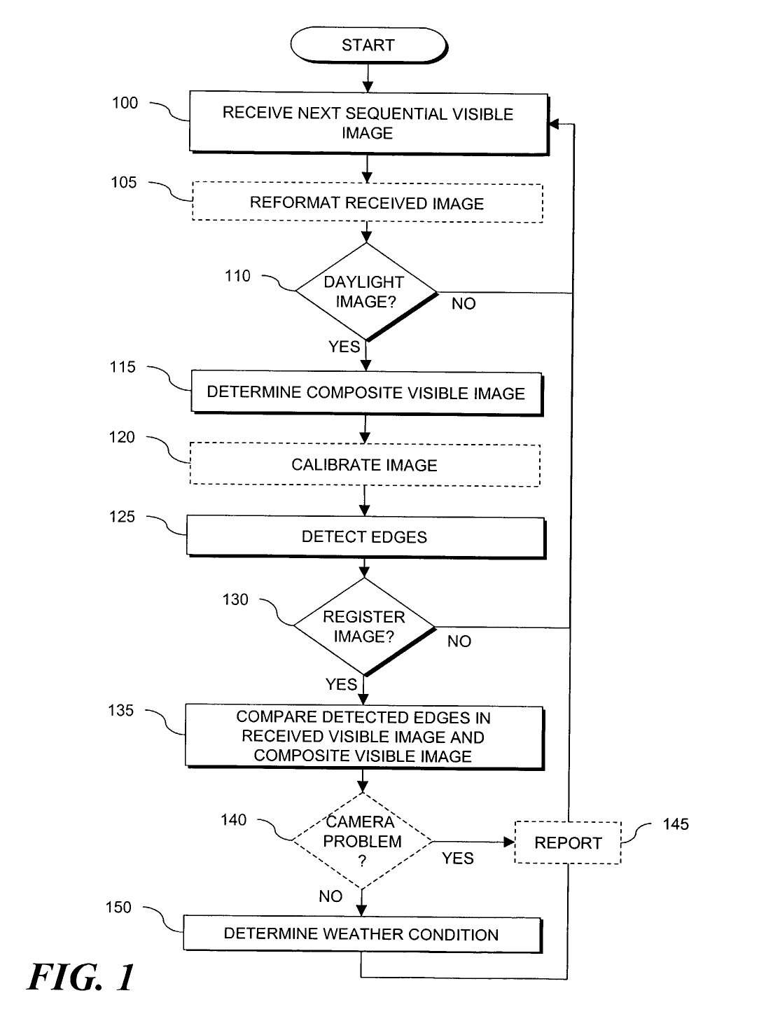

The flowchart in FIG. 1 describes one implementation of the present invention as a series of method steps for determining a weather condition based on a visible image. At step 100 a time sequence of visible images depicting substantially the same field of view is received from an image source. At step 105, each received image of the received time sequence of images is optionally reformatted to a predetermined image format. At step 110, a determination is made as to whether the currently-received image represents a daylight image. Further processing of the received image occurs if the received image is a daylight image.

At step 115, a composite visible image depicting a long-term average image of substantially the same image as depicted in the currently-received image is updated according to the currently received daylight image. At step 120, the currently-received image is optionally calibrated to adjust the mean image intensity, or brightness, according to normal daily brightness fluctuations throughout daylight hours.

At step 125, each of the calibrated currently-received image and the updated composite visible image are filtered using an edge-detection filter, resulting in a first and second edge-detected images, respectively. At step 130, the first edge-detected image is subjected to a registration process determining if the currently-received image corresponds to the composite visible image. If the currently-received image is registered, processing continues; otherwise, processing resumes with step 100, receiving the next sequential visible image.

At step 135, expected edges in the first edge-detected image are extracted and saved in an expected, edge-detected image. Generally, expected edges are persistent edges appearing in each of the sequential received visible images, and consequently appearing in the composite visible image. Examples of expected edges include such fixed items appearing within the field of view as the horizon, buildings, and roads. Conversely, unexpected edges are not persistent edges and may appear in one, or several, of the received sequential visible images. Examples of unexpected edges include such non-fixed items appearing within the field of view as vehicles on a road, airplanes, and animals.

In some embodiments, a step 140 optionally determines image sensor problems based on the nature and quantity of unexpected edges. For example, if a lens of the image sensor should become covered with rain or snow, the resulting image distortion will result in edges being detected, the edges related to the precipitation on the sensor lens. Similarly, if a sensor should become misaligned such that the field of view is shifted, the expected edges may not be detected because they are substantially shifted, or no longer within the field of view. In either instance, at step 145 a report indicating the status of the image sensor can be generated and optionally sent to a user.

Ultimately, at step 150, a predetermined weather condition is determined based on the expected edge-detected image. The predetermined weather condition includes primarily visibility; however, other weather conditions such as road-surface conditions (e.g., dry, wet, and snow covered), the presence, absence, and kind of precipitation, and wind can also be determined. For determining visibility, the field of view necessarily includes persistent objects at varied ranges (e.g., a horizon line, and a building).

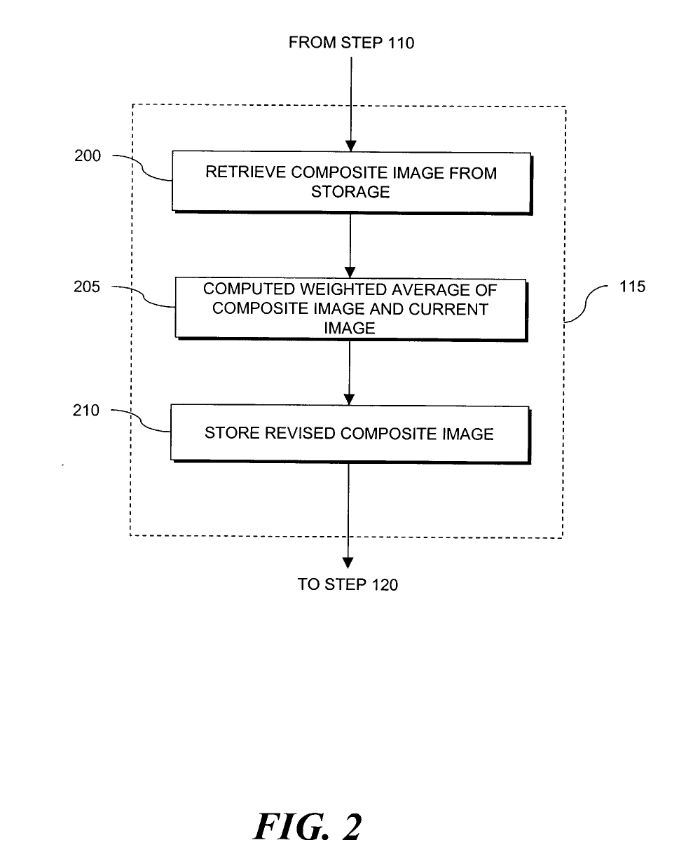

The flowchart in FIG. 2 describes in more detail one implementation of the present invention as a series of method steps for step 115 determining a composite visible image. In one embodiment, at step 200, the composite visible image is retrieved from storage (e.g., read from memory). At step 205, the retrieved composite visible image is combined as a weighted average with the currently-received visible image (step 100). At step 210, a revised composite visible image representing the combined image computed in step 205 is sent to storage (e.g., written into memory). Generally, the composite visible image represents a long-term average image, such as a thirty-day average. In some embodiments, the composite visible image represents a two-dimensional Cartesian pixel image, where each pixel stores an image intensity value (e.g., a grayscale image intensity value).

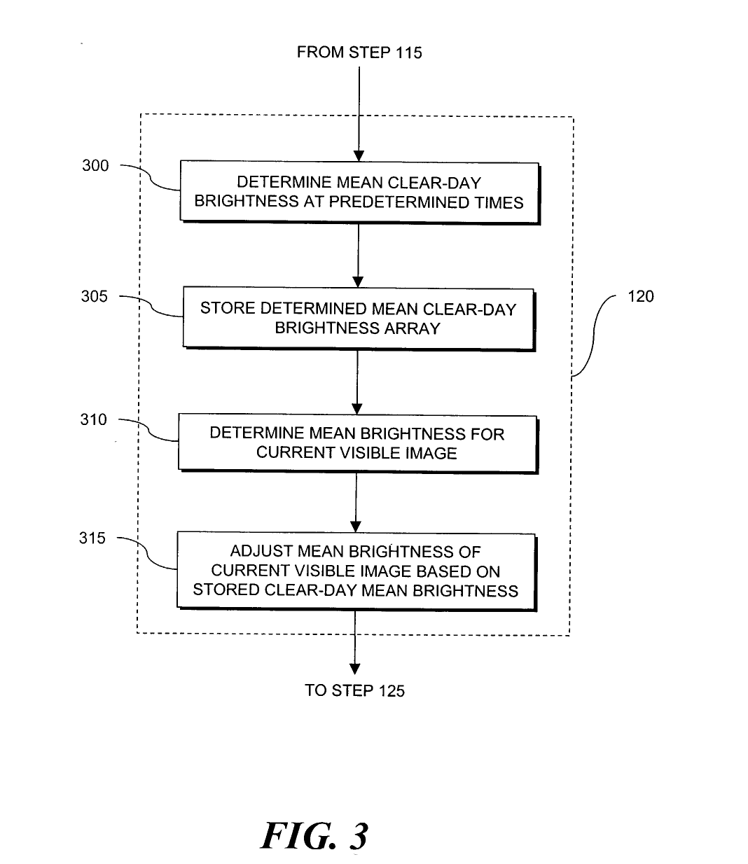

The flowchart in FIG. 3 describes in more detail one implementation of the present invention as a series of method steps for step 120 calibrating a received visible image. In one embodiment, at step 300, the mean brightness of a received image depicting the field of view is determined at predetermined times throughout the daylight hours of a clear day. At step 305, the determined mean image intensity values are then stored as an array. Generally, steps 300 and 305 are performed once, during an initialization process and the stored results used during normal processing. In another embodiment, steps 300 and 305 can be performed periodically to account for slowly-varying changes in the field of view, such as foliage changes, and seasonal changes (e.g., the angle of the sun and the presence or absence of snow). In yet another embodiment, steps 300 and 305 can be replaced by an automated measurement of the available solar energy (e.g., available solar radiation from a pyronometer). The ratio of the maximum solar energy for the site depicted in the field of view to the currently-available solar energy can then be used to normalize the brightness of each image. Once determined, the stored mean clear-day brightness can be used during all subsequent processing until the next time, the stored mean clear-day brightness is recalculated.

At step 310, the mean intensity, or brightness, is determined for the currently-received visible image. At step 315, the determined mean image brightness is compared to the stored mean clear-day brightness at an approximately corresponding time, and any differences noted can be adjusted for by adding or subtracting an intensity value to each of the pixels of the currently-received visible image. In one embodiment, the result of such an image shift tends to remove effects of brightness in an image due to solar position and reflections. For example, if the mean clear-day brightness is a maximum value at 08:00 hours, a calibration value can reduce the mean image intensity value of currently-received images at or around that time, thereby inducing a mean image intensity value for each subsequently received image to approach substantially the same value.

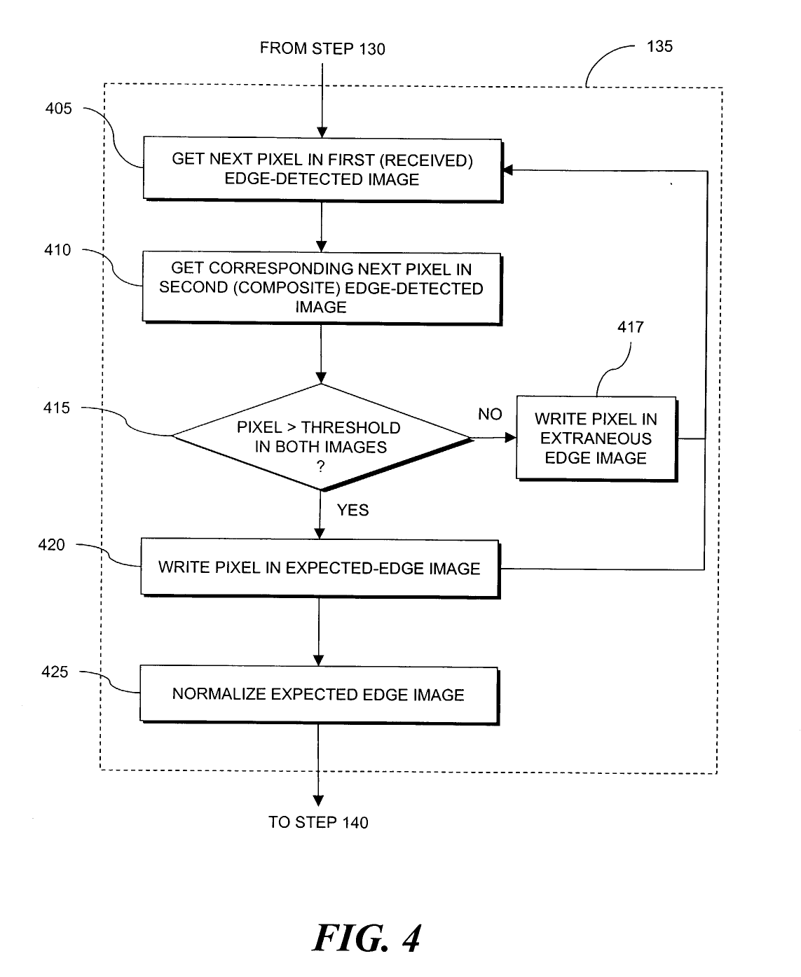

The flowchart in FIG. 4 describes in more detail one implementation of the present invention as a series of method steps for step 135 comparing detected edges between the received visible image and the composite visible image. At step 405, a first pixel of the first edge-detected image, corresponding to the currently-received visible image, is retrieved. At step 410, a corresponding first pixel of the second edge-detected image, corresponding to the composite visible image, is retrieved. At step 415, the pixel values (e.g., spectral power) for each of the first and second detected-edge images are compared to a predetermined threshold. If the corresponding pixel value in each of the first and second edge-detected images is above the predetermined threshold, the pixel value of the first edge-detected image is written into an expected-edge image; otherwise, the pixel value of the first edge-detected image is written to an extraneous image and steps 405 through 415 are repeated for subsequent pixels until substantially all pixels of the first edge-detected image are so processed. At step 425, the pixels written into the expected-edge image are normalized with corresponding pixels of the second edge-detected image. In one embodiment, the normalization is accomplished by dividing the pixel intensity value in the expected-edge image with the corresponding pixel intensity value in the second edge-detected image. A value greater than “1” generally indicates that the related edge depicted in the currently-received image is visible and sharp. Generally, the normalized value will tend to reduce as weather, such as fog, results in the edges depicted within the first edge-detected image that are less well defined than corresponding edges in the composite visible image.

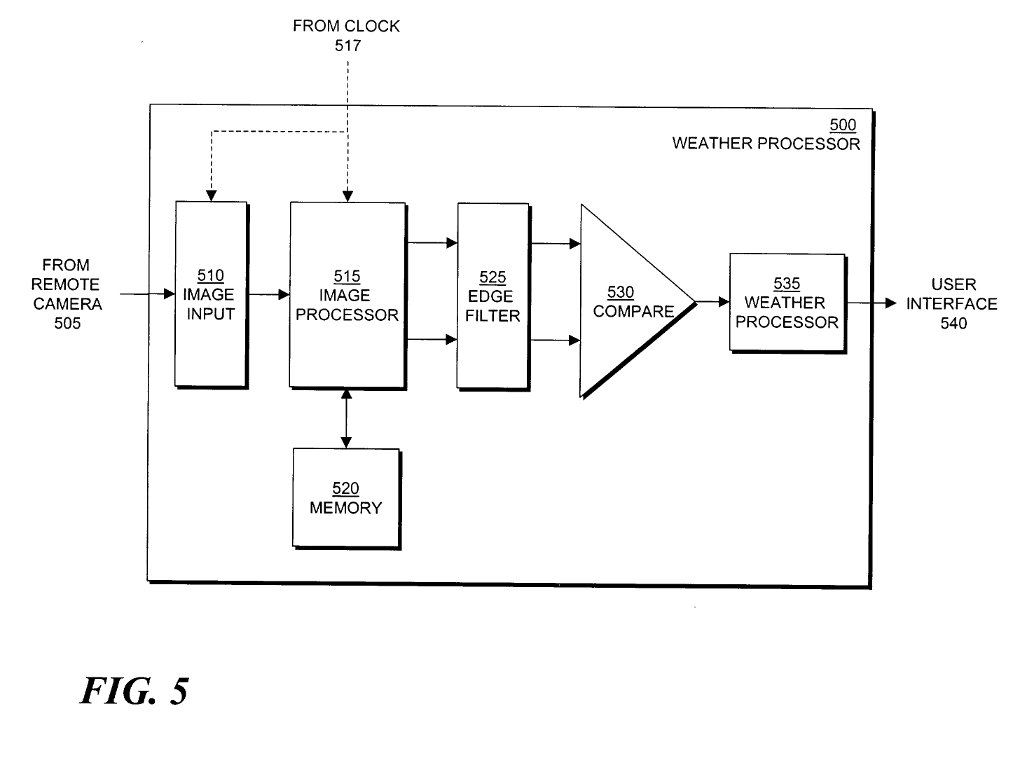

FIG. 5 shows a block diagram of an embodiment of weather processor 500 for determining a weather condition based on a visible image. The weather processor 500 includes an image input 510 receiving an input from an image-sensing device 505, such as a digital camera, a charge-coupled device, a CMOS sensor and a full-color image sensor such as the Foveon® X3, available through Foveon Inc., Santa Clara, Calif. The image-sensing device 505 can be collocated with the weather processor 500 or remotely located. An image processor 515 receives a representation of the currently-received image from the image input 510. The image processor 515 also receives a composite visible image from memory 520. In one embodiment, the image input 510 and the image processor 515 each receive an input timing reference signal from a clock 517. The image processor 515 first updates the composite visible image by weighted averaging the received image with the previously-stored composite visible image and writes the updated composite visible image to memory 520 for subsequent processing. The image processor 515 also calibrates the currently-received image according to a mean clear-day brightness, also stored and retrieved from memory 520. The image processor transmits both the updated composite visible image and the calibrated currently-received image to an edge filter 525.

The edge filter 525 processes each of the two received images, thereby generating a first and a second edge-detected images relating to the calibrated currently-received image and the composite visible image, respectively. The edge filter 525 transmits each of the first and second edge-detected images to a comparator 530. The comparator 530, on a pixel-by-pixel basis, compares the first edge-detected image to the second edge-detected image determining expected edges and extraneous edges within the first edge-detected image (corresponding to the currently-received image). The comparator 530, in turn, writes the expected edges to an expected-edge image. In some embodiments, the comparator 530 also writes the unexpected edges to an extraneous-edge image. The comparator, in turn, transmits the expected-edge (extraneous-edge) image(s) to a weather processor 535, which, in turn, generates an estimation of a weather condition and transmits the generated estimation to a user interface 540. In some embodiments, the weather processor 535 includes an image sensor status module sensing the status of the image sensor 505 from the expected-edge and/or extraneous-edge image(s).

In some embodiments, the image input 510 reformats each received images from its native image format, to a predetermined image format. For example, images can be received from one or more remote image sensors whereby each image is received according to one or more image formats, such as Joint Photographic Experts Group (JPEG), JPEG2000, Tagged-Image File Format (TIFF), bitmap, Sun rasterfile (RAS), X window system dump image (XWD), Graphics Interchange Format (GIF), and other image formats known to one skilled in the art of image capture and manipulation. Any of a number of available image converters can be used to reformat input images to a common, preferred format. In some embodiments, the image input also converts a color image to a gray-scale intensity image.

The image processor 515 includes a memory interface for reading and writing the composite visible image, and the calibration array to memory 520. The image processor also includes an image-averaging module for computing a weighted average of the currently-received image with the retrieved composite visible image. The image processor also includes an image intensity calibrator for adjusting the mean intensity of each received image according to a predetermined mean clear-day brightness calibration array. In one embodiment, the image processor adds or subtracts, as required, a mean image intensity value to each pixel value of the currently-received image.

The edge filter 525 filters each of the calibrated, currently-received image and the revised composite visible image resulting in a first and second edge-detected images, respectively. The edge filter 525 can use any method known to those skilled in the art for determining edges in a two-dimensional image file. In one embodiment, the edge filter 525 implements a two-dimensional spatial gradient measurement on a grayscale image thereby emphasizing regions of high spatial frequency that correspond to edges, referred to by those skilled in the art as an edge-detection algorithm. The edge-detection algorithm can be implemented according any of several available algorithms including Sobel, Nalwa, Canny, Iverson, Bergholm, Rothwell.

The comparator 530 is generally configured to store a predetermine threshold value. The comparator 530, the compares each of the edge-detected image on a pixel-by-pixel basis. The comparator determines a pixel to be associated with an expected edge when the pixel value (e.g., intensity) of the first and second edge-detected images are above the predetermined threshold value.

The weather processor 535 stores a predetermined scoring function based on the weather condition being monitored and also based on the particular field of view. In one embodiment, the scoring function is indicative of a relationship between the edge-detected image intensity and the weather condition, such as visibility. Accordingly, in one embodiment, the weather processor 535 determines statistics of the pixel intensity values of all of the pixels of the expected-edge image. The statistics can include the sum, the mean, the standard deviation, etc.

The weather processor 535 optionally generates messages, such as text messages, based on the resulting monitored weather condition. For example, the weather processor can assemble a text message indicating a particular image sensor, or sensed field of view, the last refresh time, and the determined weather condition (e.g., visibility), responsive to determining the weather condition. The generated text message can then be stored locally in a log file, or in a database retrievable by a user upon request, or the text message can be transmitted to one or more predetermined users via the user interface 540. In some embodiments, the user interface includes a network interface for communicating with a local area network, such as Ethernet, token ring, and/or with a wide area network, such as the Internet, packet-switched network, frame relay, asynchronous transfer mode. In some embodiments, the network interface communicates according to the TCP/IP protocol.

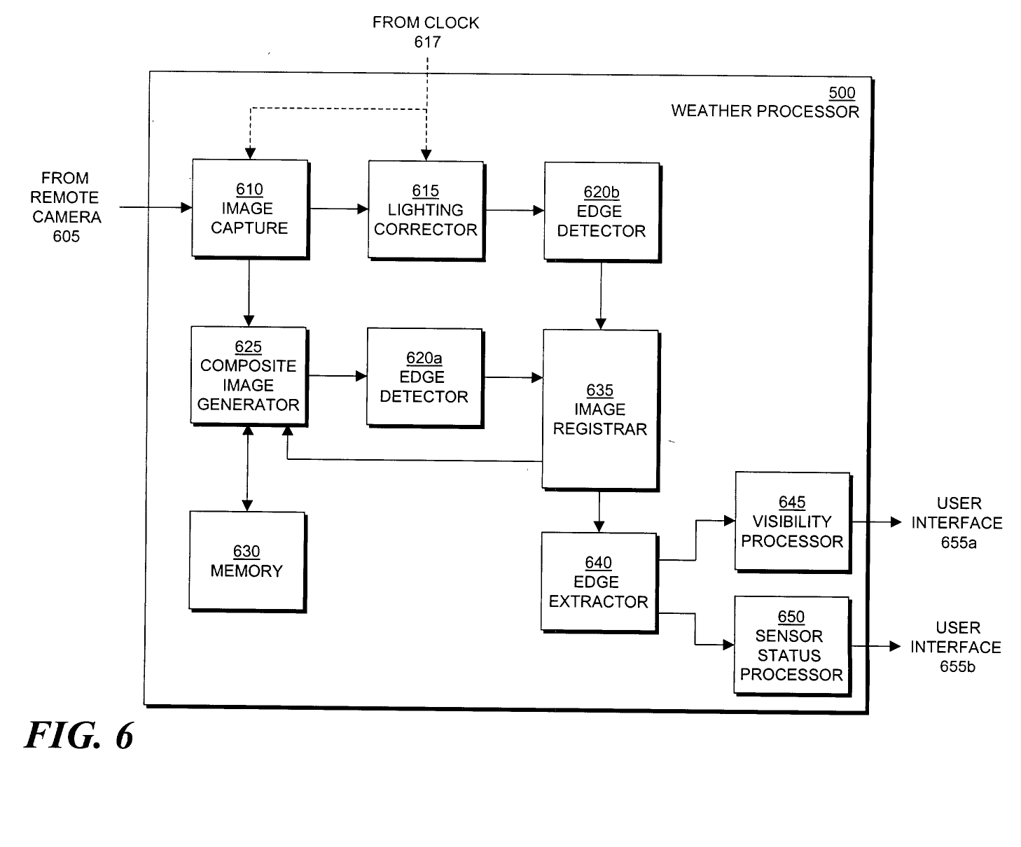

FIG. 6 shows a block diagram of an alternative embodiment of a weather processor 500′ for determining a weather condition based on a visible image. The weather processor 500′ includes an image capture module 610 receiving sequential visible images from a remote image sensor 606, or camera. Each of the received sequential visible images depicts substantially the same field of view. The image capture module 610 can reformat the image as required from a received format (e.g., JPEG, JPEG2000, GIFF, bitmap, TIF) into a preferred format for processing (e.g., a grayscale bitmap image). The image capture module 610 transmits each of the received, reformatted images to a lighting corrector module 615. The lighting corrector module 615 calibrates each received image, adjusting the image's mean intensity value to minimize intensity variations resulting due to such repeatable phenomena as changing solar positions and reflections that occur throughout any given day. The lighting corrector module 615 transmits the lighting-corrected, received image to a first edge-detector module 625a. In some embodiments, the image capture module 610 and the lighting corrector module 615 each receive an input timing reference signal from a clock 617. The first edge-detector module 625a performs a two-dimensional spatial gradient measurement, such as the Sobel edge-detection algorithm, previously discussed in relation to FIG. 5, on the received image thereby identifying edges appearing within the lighting-corrected, received image.

The image capture module 610 also transmits each of the received, reformatted images to a composite-image generator 625. In response to receiving each of the received, reformatted images, the composite-image generator 625 retrieves a composite visible image from a memory module 630. As previously discussed in relation to FIG. 5, the composite visible image depicts a time-averaged representation of substantially the same field of view depicted in each of the received, reformatted images. The composite image generator 625 then determines an updated time-average image based on the retrieved composite visible image and the received, reformatted image.

Each of the first and second edge detectors 625a, 625b transmits a respective first and second edge-detected image to an image registrar 635. The image registrar 635 compares the detected edges in each of the first and second image to determine if the first edge-detected image (corresponding to the currently-received image) is representative of substantially the same field of view. The image registrar 635 accounts for nominal shifting of the edges within the first edge-detected image to account for camera movement, or edge movement due to wind, etc. The image registrar 635 transmits an indication to the composite image generator 625 in response to determining that the first edge-detected image has been registered. The composite image generator 625 then writes the updated composite visible image to the memory module 630. If the first edge-detected image is not registered, then the updated composite visible image is not written to memory 620, thereby preventing the composite visible image from being corrupted from unregistered images.

The image registrar 635 also transmits an indication to the edge extractor 640 in response to determining whether the first edge-detected image has been registered. When the first edge-detected image has been registered, the edge extractor compares pixel intensities in each of the first and second edge-detected images to a predetermined threshold value. When the intensities of a pixel in each figure are above the threshold, the pixel value from the first edge-detected image is written into an expected-edge image. Accordingly, the expected-edge image includes expected edges, such as those edges associated with persistent objects within the field of view and excludes unexpected edges, such as those edges associated with transitory objects within the field of view.

The edge extractor transmits the expected edge image to a visibility processor 645. The visibility processor 645 then determines an estimate of the current visibility in the currently-received image. In one embodiment, the visibility processor 645 computes statistics relating to all of the pixel intensity values of the received expected-edge image. The visibility processor 645 also includes a predetermined scoring function relating the image intensity statistics to an estimate of the range of visibility. The scoring function can be determined during an initialization process, such as might occur during initial installation, or initial incorporation of images from the particular image sensor 605. In some embodiments, the scoring function is manually determined by estimating ranges to various objects within the field of view. In other embodiments, the visibility processor determines the scoring function by applying a generic scoring function developed for an embodiment of the system and adjusting the function with limited manual input. For example, a generic scoring function can be tailored to a particular field of view by measuring or estimating during an initialization procedure distances to the nearest and farthest viewable objects..

In some embodiments, the edge extractor 640 generates an extraneous-edge image including those edges appearing within the currently-received image, but not appearing within the composite visible image. Accordingly, the edge extractor 640 can write a pixel value to the extraneous-edge image in response to determining that a pixel intensity value is above the predetermined threshold in the first edge-detected image (currently-received image), while a pixel intensity value of a corresponding pixel in the second edge-detected image (composite visible image) is below the predetermined threshold. The edge extractor 640 then transmits the extraneous-edge image to a sensor status processor 650. The sensor status processor 650 makes determinations relating to the status of the image sensor 605 based on the extraneous-edge image.

Ultimately, each of the visibility processor 645 and the sensor status processor 650 generate a message indicating their respective determined status and transmit the messages to a first and second user interface 655a, 655b, respectively. In some embodiments the first user interface 655a can be a weather subscriber, whereas the second user interface 655b can be a maintenance operator. In some embodiments the messages consist of text messages describing the determined weather condition, while in other embodiments, the messages consist of text overlaying a graphic representation of the currently-received visible image. In still other embodiments, the message reporting predetermined subset of weather conditions can be machine-readable message directed to an automated system, such as a weather alarm system.

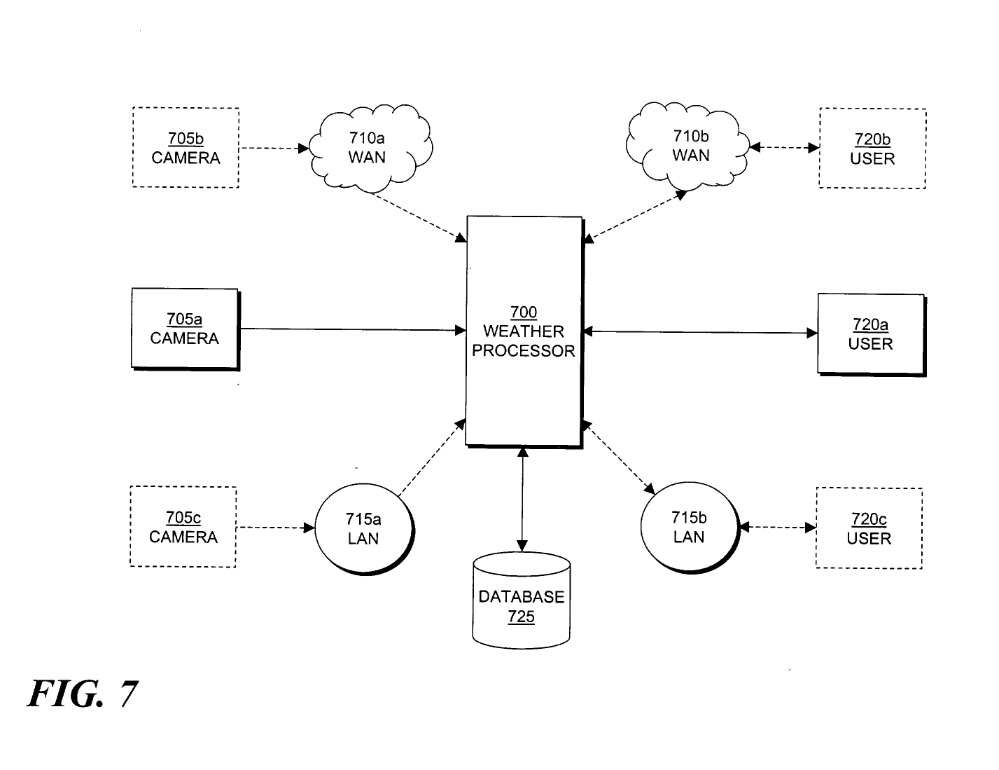

FIG. 7 shows a block diagram of an embodiment of a system for determining a weather condition based on a visible image. In general, the weather processor 700 receives input images from one or more image sensors (digital cameras) 705a, 705b, 705c (generally 705). The cameras 705 can be collocated, or remotely located and either interconnected to the weather processor 700 directly, or through a wide area network 710a, or a local area network 715a. The weather processor 700 transmits the determined weather condition, and/or camera status, to one or more remote users 720a, 720b, 720c (generally 720) via a direct connection, wide area network 710b, or a local area network 715b. In some embodiments the weather processor 700 is also in communication with a database 725 storing the determined weather conditions and/or camera status information and providing the determined weather conditions/camera status information responsive to user queries.

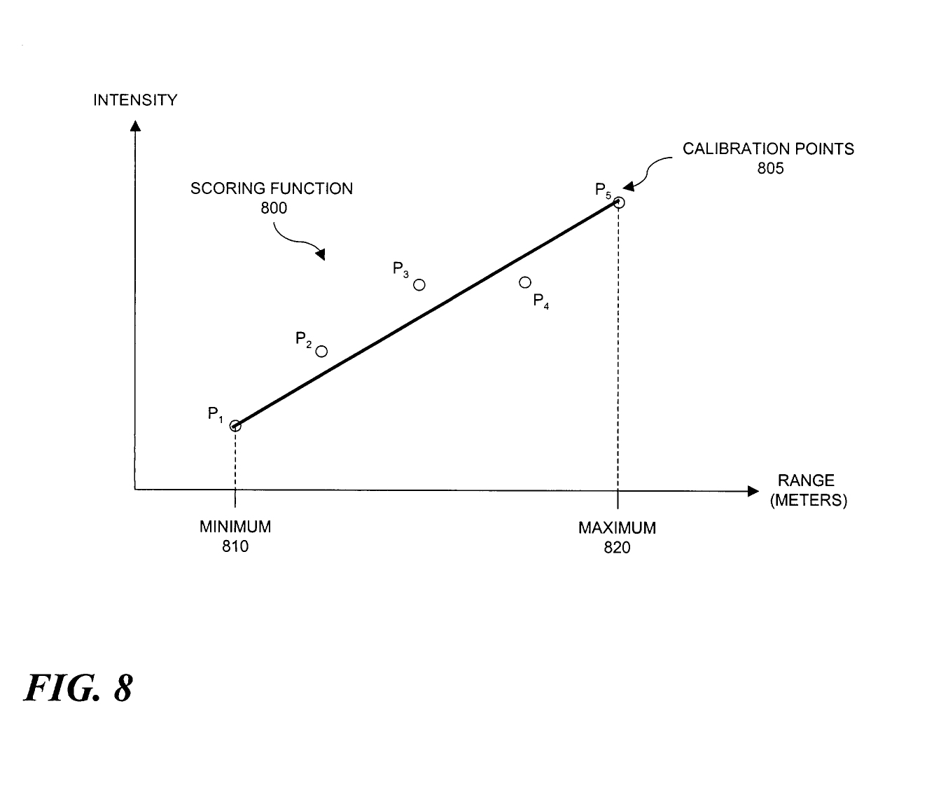

FIG. 8 shows an illustration of a scoring function 800 relating a weather parameter to the extracted, edge-detected image. The vertical axis depicts a range of intensities of the expected-edge image, whereas the horizontal axis depicts the corresponding maximum range (e.g., in meters). Generally, each scoring function 800 includes a minimum range 810 and a maximum range 820. The minimum and maximum ranges are generally related to the location of particular objects in the field of view. The scoring function 800 can be determined from a number of calibration points 805 P₁ through P₄. The calibration points 805 can be determined automatically, using another weather system or manually, using visibility estimates for the particular field of view under various visibility conditions. The continuous scoring function 800 can then be derived from the calibration points 805 through such techniques as a least-square fit for a linear curve, or cubic spline for a nonlinear curve.

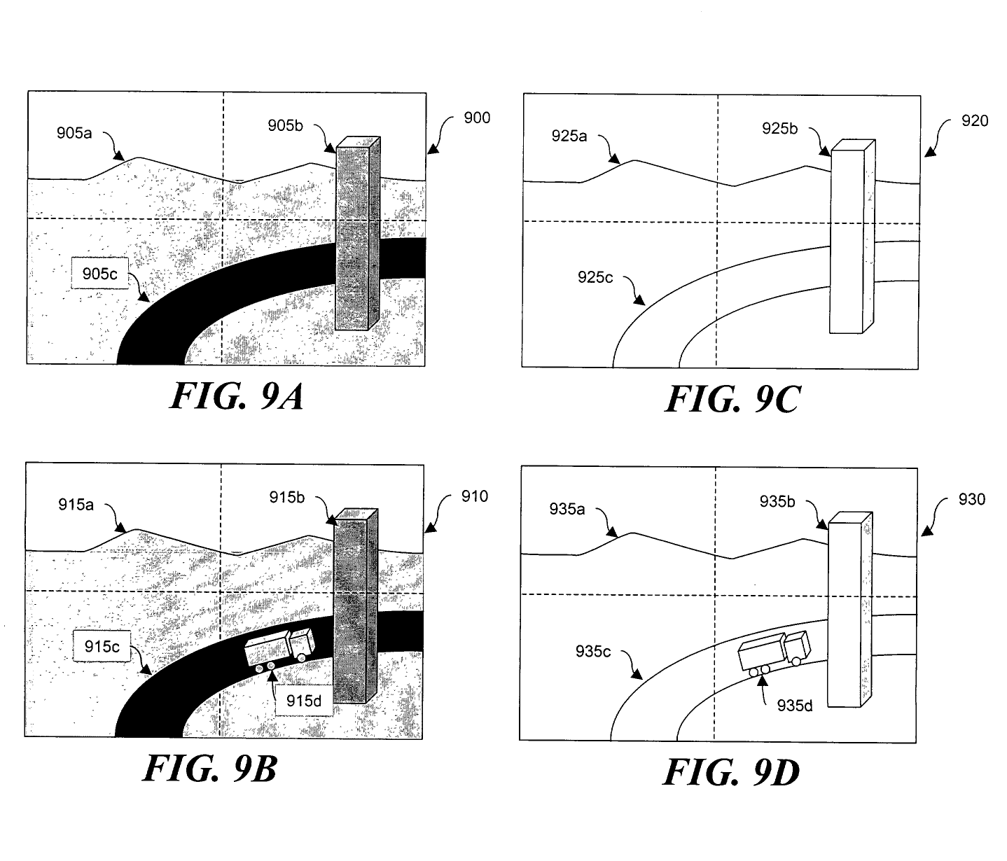

FIGS. 9A through 9D show illustrations depicting a composite visible image, a currently-received image, and each of their corresponding edge-detected images, respectively. FIG. 9A illustrates a representative grayscale, composite visible image 900 including multiple objects, such as a horizon line 905a, a building 905b, and a roadway 905c, each object residing at a different range from the image sensor. FIG. 9B illustrates a representative grayscale, currently-received image 910 depicting substantially the same field of view, depicting the same persistent objects, 915a, 915b, 915c. Notably, the currently-received image also includes a transitory object in the vehicle 915d. FIGS. 9C and 9D illustrate a second and first edge-detected images 920, 930, depicting the edges appearing in each of the composite visible image and currently-received image, respectively.

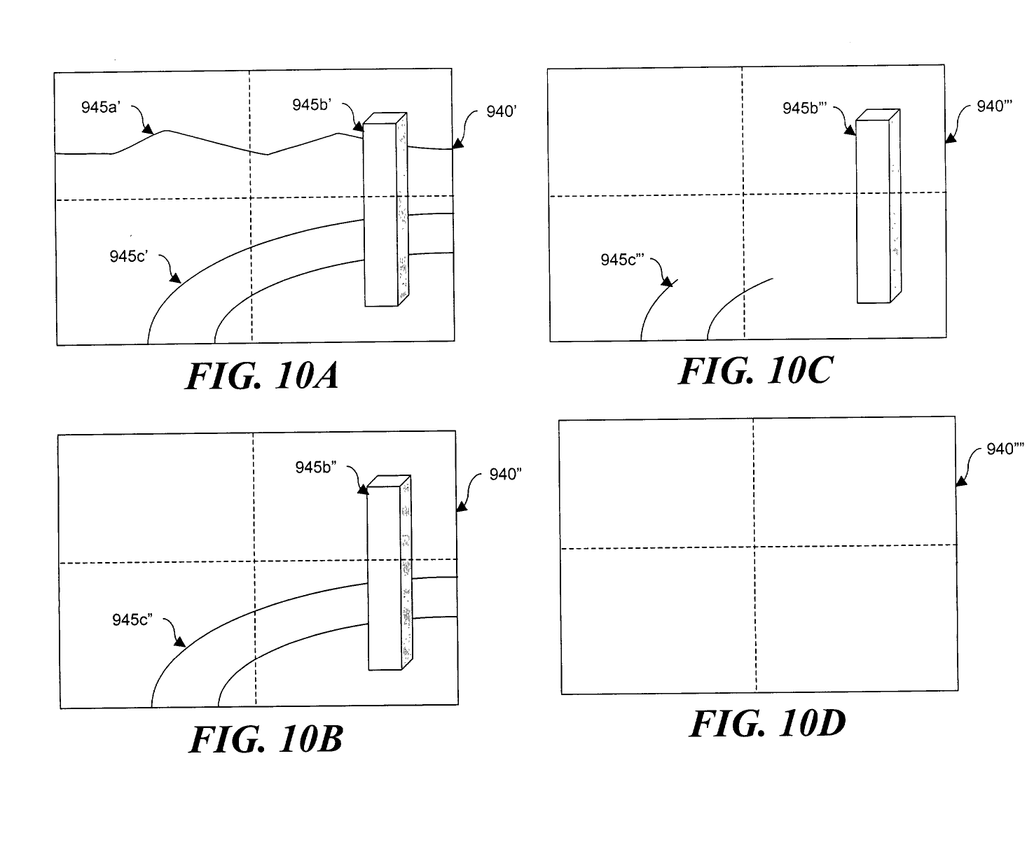

FIG. 10A illustrates an expected-edge image, determined from FIGS. 9C and 9D. Accordingly, only the persistent edges in both images are preserved and the transitory image occurring only in FIG. 9D is not included. Statistics are then gathered on the pixel intensity values of the expected-edge image and used in combination with the curve illustrated in FIG. 8 to estimate the desired weather condition. FIG. 10A is representative of a clear-day image having the most dark pixels, because all of the persistent edges are present. FIGS. 10B, 10C and 10D depict a similar expected-edge image under different weather conditions. In FIG. 10b, the horizon line 945a is no longer present. In FIG. 10C, a portion of the roadway is no longer present, and in FIG. 10D, virtually no edges are present. In the progression from FIG. 10A to FIG. 10D, each image includes less dark intensity pixels, indicating reduced visibility.

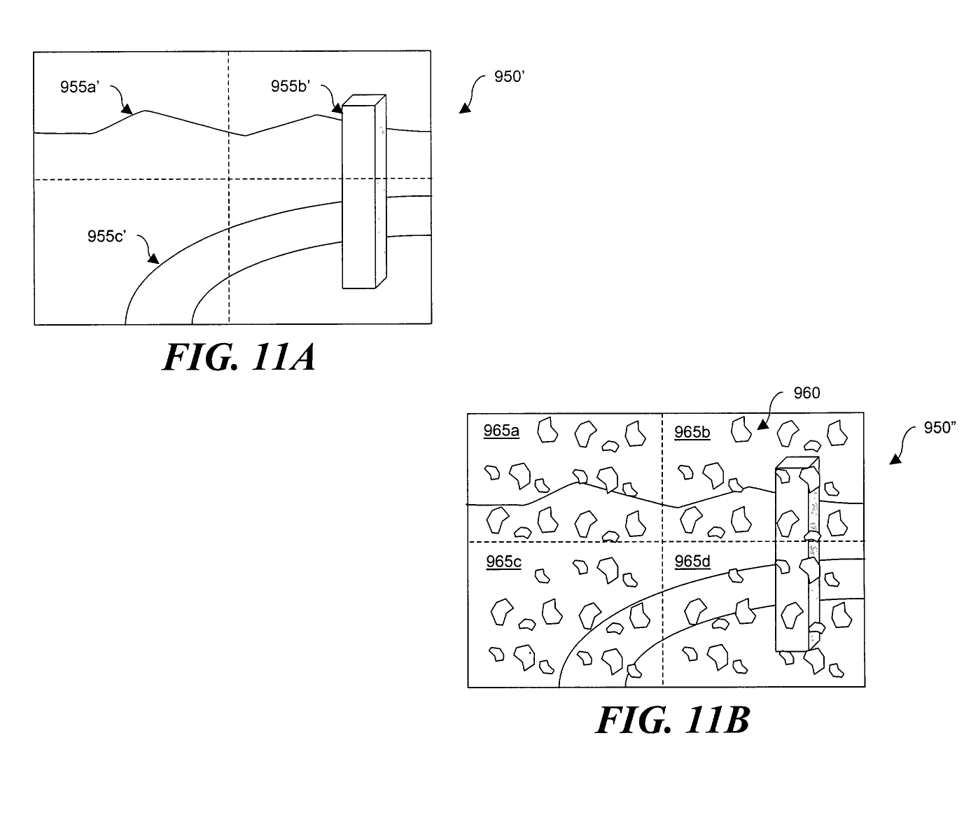

FIGS. 11A and 11B show illustrations depicting an extracted, edge-detected image and a corresponding edge-detected image under certain weather conditions. FIG. 11A illustrates an edge-detected composite visible image 950′, whereas FIG. 11B illustrates the currently-received edge-detected image 950″. The currently-received image 950″ includes edges resulting from water droplets 960 residing on the image-sensor lens. In some embodiments, the edges resulting from water droplets 960 result in substantial unexpected edges in addition to the expected edges 965a, 965b, 965c, 965d. An estimate that the image sensor has rain, or a loss of focus, can be inferred from the large number of unexpected edges.

Having shown the preferred embodiments, one skilled in the art will realize that many variations are possible within the scope and spirit of the claimed invention. It is therefore the intention to limit the invention only by the scope of the claims.

What is claimed is:

1. A computerized method for determining a weather condition using visible imagery comprising the steps:
receiving a plurality of sequential visible images each depicting substantially the same field of view;
determining based on the received plurality of sequential visible images, a composite visible image depicting the field of view;
generating a first and second edge-detected images based on one of the plurality of sequential visible images and the composite visible image, respectively;
comparing the fist and second edge-detected images; and
determining a weather condition based on the comparison of edge-detected images.

2. The method of claim 1, wherein the receiving step comprises receiving the plurality of sequential visible images from an image detection device.

3. The method of claim 2, wherein the image detection device comprises a digital camera.

4. The method of claim 1, wherein the receiving step comprises receiving the plurality of sequential visible images via a network interface.

5. The method of claim 1, wherein each of the plurality of sequential visible images comprises a graphical image selected from the group including: JPEG, JPEG2000, TIFF, bitmap, GIF.

6. The method of claim 1, further comprising the step of converting each of the received plurality of sequential visible images.

7. The method of claim 1, further comprising the step of discarding each of the received plurality of sequential visible images depicting the field of view during nighttime hours.

8. The method of claim 1, wherein the step of determining the composite visible image comprises averaging the received plurality of sequential visible images.

9. The method of claim 8, wherein the averaging step comprises weighted averaging the composite visible image with a currently-received visible image of the plurality of sequential visible images.

10. The method of claim 1, further comprising the step of calibrating each of the received plurality of sequential visible images correcting for daily variations in lighting.

11. The method of claim 10, wherein the calibrating step comprises the steps:
determining a mean clear-day brightness for each of the plurality of sequential visible images received on a clear day;
storing the determined clear-day mean brightness;
determining a mean brightness for each of the plurality of sequential visible images; and
adjusting, for each of the received plurality of visible images, image intensity based on the stored clear-day brightness.

12. The method of claim 1, wherein the generating step comprises edge-detection filtering each of the currently-received visible image of the plurality of sequential visible images and the composite visible image.

13. The method of claim 1, further comprising the step of registering each of the received plurality of sequential visible images.

14. The method of claim 13, wherein the registering step comprises the steps:
comparing the first and second edge-detected images;
determining that the first edge-detected image depicts substantially the same field of view as the second edge-detected image; and
registering the first edge-detected image responsive a determination that the fist edge-detected image depicts substantially the same field of view as the second edge-detected image.

15. The method of claim 14, wherein the determining step comprises correlating the first and second edge-detected images.

16. The method of claim 1, wherein the comparing step comprises extracting expected edges and normalizing the extracted edges.

17. The method of claim 16, wherein the extracting step comprises the steps:
comparing for each pixel of the first edge-detected image, a first pixel value to a predetermined threshold value;
comparing for each pixel of the second edge-detected image corresponding to the pixel of the first edge-detected image, a second pixel value to the predetermined threshold value; and
keeping the pixel value of the first edge-detected image responsive to the first pixel value and the second pixel value being greater than the predetermined threshold.

18. The method of claim 17, further comprising the step of writing the pixel value of the first edge- detected image to an extraneous edge image responsive to the first pixel value being greater than the predetermined threshold and the second pixel value being not greater than the predetermined threshold.

19. The method of claim 16, wherein the step of normalizing comprises dividing the first edge-detected image by the second edge-detected image.

20. The method of claim 1, wherein the step of determining a weather condition is based on the comparisons of the first and second edge-detected images.

21. The method of claim 1, wherein the step of determining a weather condition is based on a predetermined scoring function.

22. The method of claim 1, wherein the weather parameter comprises visibility.

23. The method of claim 1, further comprising the step of determining status of an image detection device based on the first and second edge-detected images.

24. The method of claim 1, further comprising the step of sending the determined weather condition to a user interface.

25. An apparatus for automatically determining a weather condition using visible imagery comprising:
an image input receiving a plurality of sequential visible images each depicting substantially the same field of view;
an image processor in communication with the image input determining a composite visible image depicting the field of view based on the received plurality of sequential visible images;
a filter in communication with the image input and the image processor generating a first and second edge-detected images based on one of the plurality of sequential visible images and the composite visible image, respectively;
a comparator in communication with the filter comparing the fist and second edge-detected images; and
a weather processor in communication with the comparator determining a weather condition based on the comparison of edge-detected images.

26. The apparatus of claim 25, wherein the image input receives the plurality of sequential visible images from an image-detection device.

27. The apparatus of claim 25, wherein the image input device comprises a digital camera.

28. The apparatus of claim 25, wherein the image input comprises a network interface.

29. The apparatus of claim 25, wherein the image processor comprises a memory storing the composite visible image; and
a weighted-averaging filter updating a weighted average of the composite visible image and a currently-received one of the plurality of sequential visible images.

30. The apparatus of claim 25, wherein the image processor comprises a brightness calibration filter adjusting a mean image intensity of the currently-received image according to a predetermined relationship.

31. The apparatus of claim 25, wherein the filter comprises an edge-detection filter filtering each of a currently received one of the plurality of sequential received visible images and the composite visible image.

32. The apparatus of claim 25, wherein the comparator comprises:
a correlative filter correlating the detected edges of a currently-received one of the plurality of sequential visible images; and
a registration processor registering the detected edges according to the correlation.

33. The apparatus of claim 25, wherein the weather processor comprises an image processor determining the weather condition based on the comparison of the first and second edge-detected images.

34. The apparatus of claim 33, further comprising a pre-determined scoring function based on a relationship between detected edges and the weather parameter.

35. The apparatus of claim 33, further comprising a user interface.

36. A computerized apparatus for determining a weather condition using visible imagery comprising:
means for receiving a plurality of sequential visible images each depicting substantially the same field of view;
means in communication with the receiving means for determining based on the received plurality of sequential visible images, a composite visible image depicting the field of view;
means in communication with the receiving means and the determining means for generating a first and second edge-detected images based on one of the plurality of sequential visible images and the composite visible image, respectively;
means in communication with the receiving means and the generating means for comparing the fist and second edge-detected images; and
means in communication with the comparing means for determining a weather condition based on the comparison of edge-detected images.

37. The apparatus of claim 36, wherein the generating means comprises an edge-detection filter.

38. The apparatus of claim 36, wherein the receiving means receives the plurality of sequential visible images from an image-detection device.

39. The apparatus of claim 38, wherein the image input device comprises a digital camera.

40. The apparatus of claim 36, wherein the weather condition comprises visibility.

41. The apparatus of claim 36, further comprising a means for interfacing with a user.
